(19) United States
(12) Patent Application Publication
(10) Pub. No.: US 2022/0109760 A1
(43) Pub. Date: Apr. 7, 2022

(54) Automatic Call Categorization and Expense Calculating System and Method

(71) Applicant: Tiffany Johnson, San Diego, CA (US)

(72) Inventor: Tiffany Johnson, San Diego, CA (US)

(21) Appl. No.: 17/449,207

(22) Filed: Sep. 28, 2021

Related U.S. Application Data
(60) Provisional application No. 63/087,035, filed on Oct. 2, 2020.

(51) Int. Cl. H04M 15/00; H04W 4/24

(52) U.S. Cl. CPC H04M 15/80; H04M 15/82; H04W 4/24

(57) ABSTRACT

A Mobile application software that auto-classifies phone calls as “Personal” or “Business” for recognized numbers, and allows users to manually classify other numbers as being personal or business. The system automatically characterizes certain calls, either based on preset instructions, or based on operations that the user has previously carried out.

This application claims priority from Provisional application No. 63/087,035, filed Oct. 2, 2020, the entire contents of which are herewith incorporated by reference.

### BACKGROUND

Many business expenses can be tracked with receipts and credit card statements. Mobile phone expenses, specifically business-related call time on users' personal mobile phones, have not historically been efficiently trackable.

The requirements for tax purposes, and usually also for employer reimbursement, are that a user—a small business owner, self-employed professional, or IRS-allowed traditional employee—track the following information for every phone call: phone number, call time, date of call, and purpose of call.

Some small business owners often purchase a separate mobile phone strictly for business purposes and deduct the entire phone bill of that phone to avoid the hassle of logging their business-related phone usage of their personal phone as it is too difficult a process. Those who log their business calls tend to rely on either a printed hardcopy phone bill with marked individual business-related phone call used calculate monthly expenses for business-related usage only, or alternatively try to use an estimated yearly business-related usage. Those who use the latter system run the risk of tax penalties for inaccuracies.

Previous systems of tracking such cell phone uses have in common is that a user still needs to actively log the purpose of each phone call at the start and end of a phone call, which can be time-consuming and tedious.

### SUMMARY OF THE INVENTION

The invention provides a method and system for collecting phone call time and screen time data from the mobile device, for the purpose of categorizing phone calls as business or personal, in order to calculate monthly business expenses of a personal mobile phone for annual tax deductions or accurate employee reimbursement.

The inventor recognized a need and use for a phone call tracking system that can capture all the required phone call information in the background, without the need for additional dedicated hardware, and that can allow creation of phone logs, accepts information from the user to complete their phone logs on their own schedule and directly from their mobile device while still meeting the standards of timeliness and accuracy.

The inventor recognized a further need to simplify the process of classifying and submitting call logs for reimbursement or tax purposes.

Embodiments provide techniques that provide an expense tracking application that runs on a cellular phone and has certain advantages. The features include, among other features,

A Smartphone application that leverages the computing and location powers of the mobile phone to capture user phone call classification automatically and present them in an easy-to-modify and easy-to classify interface

A browser interface that presents the same phone call log information but with additional functionality, and also one or more systems and databases in the cloud that can process phone call log information, algorithmically classify phone call information, and enable the user to submit their call time information via printout, email, spreadsheet, or integration with tax, accounting, expensing and invoicing tools.

The techniques provide an intuitive interface, a simple mechanism for classifying phone calls, cloud storage, and reporting for tax, expense, invoicing and accounting needs. These and other features are described throughout the specification and more particularly below.

### BRIEF DESCRIPTION OF THE DRAWINGS

In the Drawings:

the figures show aspects of the invention, and specifically,

FIG. 1 shows a block diagram and functional flowchart according to an exemplary embodiment;

FIG. 2 shows a screen showing information about data systems, including and overview and specific information about the different calls;

FIG. 3 illustrates an operation of categorizing a specific call;

FIG. 4 illustrates an account settings update page;

FIG. 5 illustrates details on the account setting page;

FIG. 6 illustrates a page showing frequent Numbers that are called, and characterization of those frequent Numbers; and

FIG. 7 shows a hardware diagram of a cellular phone with processor.

### DETAILED DESCRIPTION

The present invention describes an application running on a cell phone, referred to herein as Phonetaxx, that facilitates the logging of and analysis of mobile calls, and which provides users with tools to categorize their mobile phone calls.

The system operates as follows. A mobile phone 100 is shown having a screen 105, a memory 110 and a processor 120. The processor operates to execute instructions in the memory and displays information on the display 105.

It should be understood that this system can be operated on the mobile phone itself, for example as an app on the mobile phone. Alternatively, however, the information collected by the mobile phone can be set to a backend server, and the system can analyze determine information can be initiated from any kind of computer terminal, since the login and password provides access to a remote server that is receiving data for monitoring the phone calls. The data received from this backend server can also be accessed via a screen of this type, if desired.

In operation, an app running on the processor on the phone executes an application program that captures information about incoming and outgoing calls at 130. The application program is set to monitor all calls, both incoming and outgoing at 140. The system creates and maintains a log including at least the phone number of the call, the date and time of the call, and the amount of time that the user was on the call.

The application also includes a database 150 which is created and maintained by the app as described herein. The database includes information about multiple numbers, which is initially populated as described herein. In one embodiment, the database can be part of or communicating with the call log on the phone.

At 160, the application either automatically identifies the call as being business or personal, or prompts the user to identify the call. In this way, the system can track phone call time and automatically classify each call as either “business” or “personal” along with tracking the amount of time of both business and personal calls on the cellular phone. This is done as described herein, based on information entered by the user via the various screens of the system.

In one embodiment, the user sets preferences for commonly used phone numbers, and those phone numbers are automatically populated into the system with those preferences.

In another embodiment, the user characterizes each call as being business or personal, and that characterization carries over to further instances where that phone number is either an incoming or outgoing phone call.

At 170, the information is synced with a backend server, so that the information obtained and processed as described herein is maintained on another server.

In operation, the user first signs into their account on the system. This is done using, for example, a conventional login and screen including username and password, or asking for a one time code, or logging in using an alternative login system such as Facebook or the like.

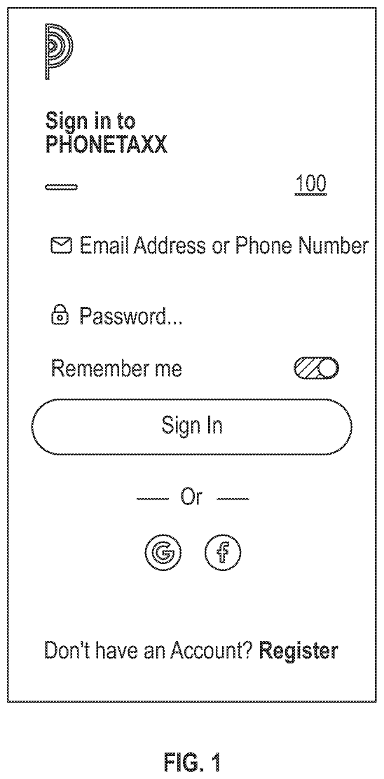

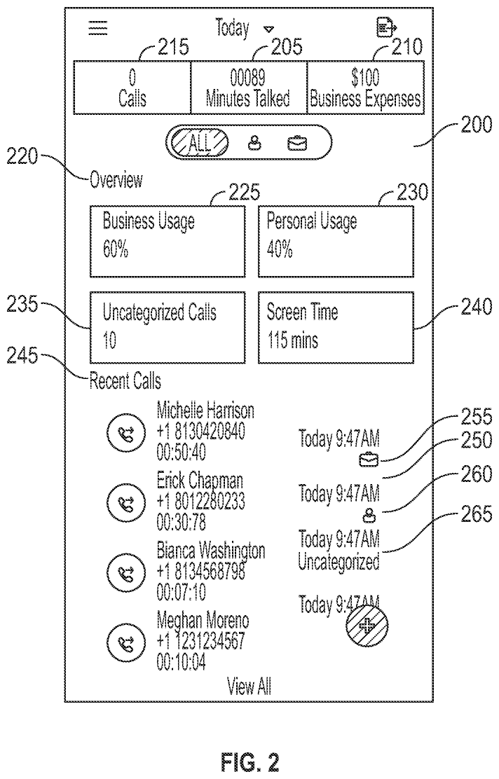

After signing in, the user receives the homepage screen 200 shown in FIG. 2, which shows different information about cellular phone usage as tracked by the act running the steps shown in FIG. 1.

The User Home page displays the summary section 200 which allows a user to select the period, here shown as today. The view period is selectable between today, current week, current month, or other time period. For the selected period, the system shows the total minutes talked at 205, the total part of this that is business expenses at 210, and the total number of calls at 215.

Other data is also provided, in the overview section 220, which shows how the calls have been categorized between business usage 225 and personal usage 230. The overview also shows the total number of uncategorized calls 235, providing a reminder to the user that they need to categorize those calls. The total screen time 240 is also provided.

A list of recent calls 245 is shown at the bottom of the screen. The recent calls such as 250 are shown with an icon that indicates that the current categorization status for the call: whether the call is categorized as a work call by showing icon 255, or a personal call by displaying an icon 260 indicating work, or with an indication icon 265 that the call is uncategorized.

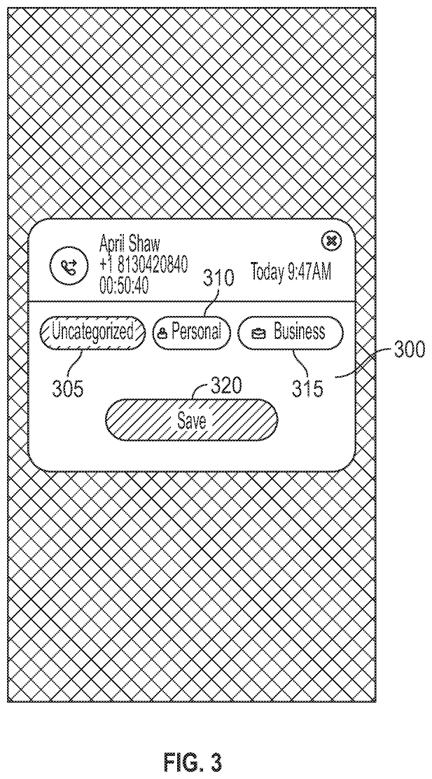

The user can click on an indication of a call, in order to characterize the call. When the user clicks on a particular call indication, they receive the screen shown 300 shown in FIG. 3 which allows categorization of uncategorized phone calls. The user can quickly characterize the call from its current level of uncategorized at 305, to either be personal 310 or business 315. The user then saves this information using the save button 320. As described herein, the system learns from this categorization to create future categorizations for this same phone number, in one embodiment.

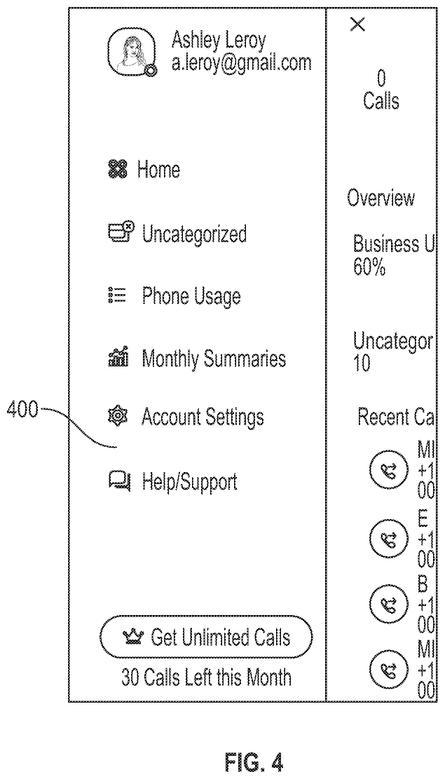

The main menu also has a list of application settings, shown in FIG. 4, that a user can modify for their needs and used to help find details about their phone use. The settings section 400 includes a button 405 for home, another button 410 which brings up the list of uncategorized calls which can be categorized later on, a button 415 for phone usage. Another selection is the monthly summaries 420, the account settings 430, and to help support 440.

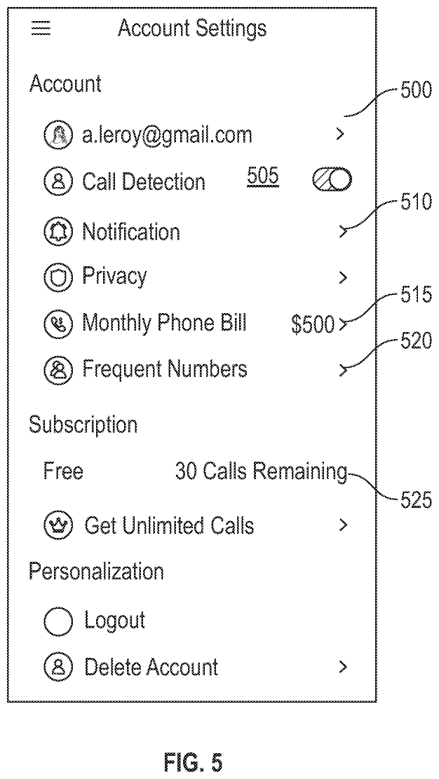

Bringing up the account settings 430 provides the account settings page 500 shown in FIG. 5. The account Settings allow a user to control whether the app detects calls from the call log or not at 505; whether or not Notifications are being pushed to inform the user of uncategorized calls at 510; and prompts the user to input their Monthly Phone Bill Amount, which will serve as the denominator for the software calculating the Business-related percentage and Business-related expenses in dollars.

520 allows the user to enter Frequent Numbers that are automatically classified as being either business or personal every time those numbers occur. The user can also change their subscription type to the app at 525.

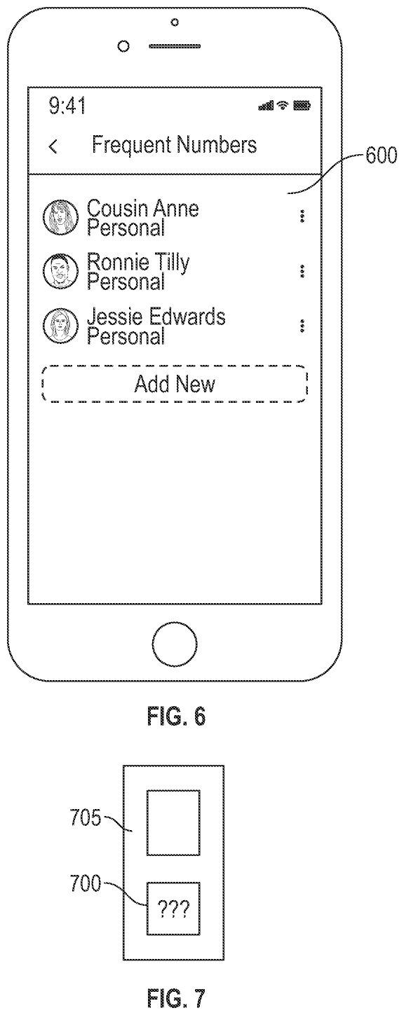

The frequent Numbers entered at 520 are shown in detail in the page 600 of FIG. 6. Frequent Numbers setting allows a user to input numbers and select the classification as Personal or Business, so subsequent calls will be auto classified. This auto-classification is a main critical setting that will eliminate or minimize manual classification in the application.

In one embodiment, all calls that are classified in one way or the other are automatically added to the frequent Numbers section of FIG. 6.

The method includes using a mapping module to copy the phone call log for the mobile wireless device.

This invention allows for improved cost control and greater tax savings due to greater tax deductions by auto-classifying phone calls. A small business owner can require employees to download this app and track business-related phone calls so it reimburses employees exact business-related expenses and not an estimated amount of their personal phone bill. A small business owner or self-employed professional can claim more accurate deductions and integrate this application with other tax software.es.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A programmed phone device, comprising:
a mobile phone, having a processor which runs a program to capture call information and create a log of the call information, and to automatically process individual calls found within the call information by analyzing each individual call, and categorizing each individual call as one of a work based call or a personal based call, or an uncategorized call,
the mobile phone programmed for automatically creating of a list of the uncategorized calls,
and the mobile phone programmed accepting input from a user to categorize the uncategorized call as being a business call or a personal call, and
the mobile phone programmed creating information indicating a percentage of total calls that are personal and another percentage of total calls that are business based calls.

2. The device as in claim 1, wherein further comprising receiving an amount of a monthly phone Bill, and determining, based on the categorizing, a part of the monthly phone Bill that represents a business expense.

3. The device as in claim 1, further comprising displaying a list of uncategorized calls, and accepting you wherein the system determines a percentage of the phone operation that is business usage and a percentage that is personal usage.

4. The device as in claim 1, further comprising receiving information from a user about frequent persons called, and indicating for each frequent person called whether the call is personal or business.

5. The device as in claim 1, further comprising, responsive to the accepting input from the user, learning from the input and subsequently automatically categorizing calls to or from the same number the same way as they are categorized during the accepting input.

6. The device as in claim 2, further comprising displaying an amount of the monthly phone Bill that is personal charges.

7. The device as in claim 2, further comprising displaying an amount of the monthly phone Bill that is business charges.

8. A method of categorizing calls made and received from a mobile phone, comprising:
in a processor of a mobile phone, running a program to capture call information and create a log of the call information,
and to automatically process individual calls found within the call information by analyzing each individual call,
and categorizing each individual call as one of a work based call or a personal based call, or an uncategorized call,
automatically creating of a list of the uncategorized calls,
accepting input from a user to categorize the uncategorized call as being a business call or a personal call, and
creating information indicating a percentage of total calls that are personal and another percentage of total calls that are business based calls.

9. The method as in claim 8, wherein further comprising receiving an amount of a monthly phone Bill, and determining and displaying, based on the categorizing, a total amount that represents a business expense.

10. The method as in claim 8, further comprising receiving information from a user about frequent persons called, and indicating for each frequent person called whether the call is personal or business.

11. The method as in claim 8, further comprising, responsive to the accepting input from the user about uncategorized, learning from the input and subsequently automatically categorizing calls to or from the same number the same way as they are categorized during the accepting input.
